(19) United States
(12) Patent Application Publication
(10) Pub. No.: US 2011/0056115 A1
(43) Pub. Date: Mar. 10, 2011

(54) Weight for a fishing hook

(75) Inventor: Patrick Sébile, Monument, CO (US)

(73) Assignee: Sebile International, S.A., Peppange (LU)

(21) Appl. No.: 12/835,200

(22) Filed: Jul. 13, 2010

Related U.S. Application Data
(60) Provisional application No. 61/225,320, filed on Jul. 14, 2009.

(51) Int. Cl. A01K 83/00

(52) U.S. Cl. 43/44.81

(57) ABSTRACT

A weight for use in fishing including a hook having a body and a weight collar having a cylindrical shape and a bore formed therein. The weight collar is made of a soft material including a heavy material, and wherein the body of the hook is received in the bore to locate the hook at a desired location on the body of the hook.

### CROSS REFERENCE TO RELATED APPLICATIONS

The present application claims the benefit of priority under 35 USC §119(e) to U.S. Application No. 61/225,320, entitled “Weight For a Fishing Hook”, filed Jul. 14, 2009 and which is hereby incorporated by reference in its entirety.

### TECHNICAL FIELD

The technology disclosed herein relates to weights configured to be applied directly to the fish hook. More particularly, implementations of weights comprise a deformable soft material impregnated with metal particles configured to be engaged with and disengaged from a fish hook.

### BACKGROUND

Weights for fishing are typically attached to the line above the lure. Traditional weights are either tied to the line, or are made of a metal that can be clamped on the line. These types of hooks have only some effect on the lure, which is typically at least several inches below the weight, and in some instances, several feet below the weight.

The information included in this Background section of the specification, including any references cited herein and any description or discussion thereof, is included for technical reference purposes only and is not to be regarded subject matter by which the scope of the invention is to be bound.

### SUMMARY

Disclosed herein is a weight for use in fishing hook. In one embodiment, the weight includes a hook having a body including a shank, an eyelet end, and a barb end and at least one repositionable weight collar configured to be positioned on said body of said hook. The weight collar may be comprised of a deformable material comprising heavy particles. The deformable material may be plastic, natural rubber, or other material. The heavy particles may be lead, iron, bismuth, tungsten, stone, or other similar materials, or combinations thereof. The hook may be a single hook, a dual hook, a treble hook, or a quad hook. In some embodiments, the weight collar further comprises a bore configured to receive the shank of the hook or other portion of the hook. In some embodiments, the bore of the weight collar further comprises a slit configured to aid the bore to receive at least a portion of the body of the hook.

In another embodiment, the weight includes a hook having a body and a weight collar having a cylindrical shape and a bore formed therein, said weight collar being made of a soft material including a heavy material; wherein said body of said hook is received in said bore to locate said hook at a desired location on said body of said hook. The soft material may be plastic, natural rubber, or other similar material. The heavy material may be lead, iron, bismuth, tungsten, stone, or other similar materials, or combinations thereof. The hook may be a single hook, a dual hook, a treble hook, or a quad hook.

In an alternate embodiment, a kit includes a fishing hook having a body and at least one weight collar configured to be positioned on the body of the hook. In some embodiments, the kit may further include a lure. In some embodiments, the kit may further include instructions for positioning the at least one weight collar on the body of the hook. The hook may be a single hook, a dual hook, a treble hook, or a quad hook. The weight collar may be comprised of a deformable material comprising heavy particles. The deformable material may be plastic, natural rubber, or other similar material. The heavy particles may be lead, iron, bismuth, tungsten, stone, or other similar materials, or combinations thereof.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 shows a hook utilized with a weight collar according to one aspect of the present invention.

FIG. 2 shows a plurality of weight collars configured to be utilized with the hook of FIG. 1 according to one aspect of the present invention.

FIG. 3 shows a plurality of weight collars positioned along the length of a shank of the hook as shown in FIG. 1.

FIG. 4 shows a weight collar positioned over a barb on the hook as shown in FIG. 1, and two weight collars positioned adjacent one another on the shank.

FIG. 5 shows a cross section taken along line 5-5 of FIG. 2.

### DETAILED DESCRIPTION

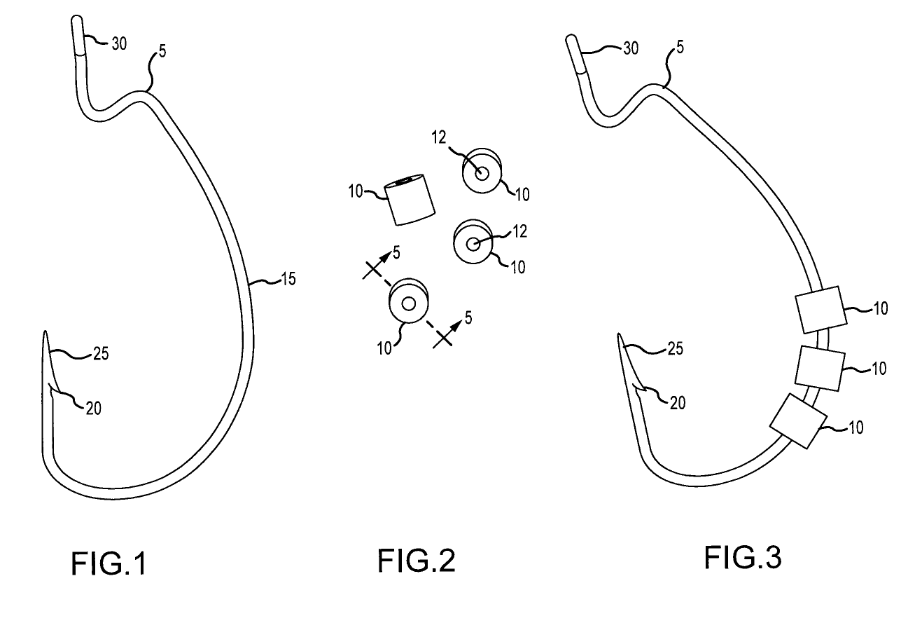

FIG. 1 shows a fishing hook 5 often used for fishing. The hook 5 (or hook body) includes a top eyelet 30 for attachment to a fishing line (not shown), a shank 15 that is generally curved, arcuate, or “C” shaped, and a tip 25 including a barb 20 on which the fish typically bites and cannot easily extract itself. In some embodiments, the hook 5 may be a single hook. In other embodiments, the hook 5 may be a dual, treble, quadruple prong or other hook structure. Each prong on a particular hook style may have one or more barbs as desired.

The hook 5 shown in FIG. 1 may be used alone, or in conjunction with a lure. The lure may be attached on the fishing line above the hook 5 (such as a spinner), or the hook 5 may attach to an end of a lure (such as a spoon with a treble hook). Also, the lure may incorporate the hook 5 into its lure body, such as in a Slimstick™ by Sebile USA. Further, the hook 5 may be an integral part of the lure, such as in a soft body lure where a hook extending from a jig head is pushed through the soft plastic body.

Weights are typically used to help insure that the hook or lure (sometimes the hook is the lure) is positioned at the desired depth of water, as well as to help provide some mass for casting the lure to the desired location. The benefit of aiding in reaching the desired depth is apparent whether or not the hook is used in a stationary manner (such as with a bobber) or is trolled or otherwise used dynamically (such as trolling from a boat, or cast out and reeled in). The weights are typically made of solid metal, such as lead, and are designed to clamp onto the line or tie onto the line using an eyelet. While these existing weight structures are likely to have some effect on the motion of the lure, the primary purposes of the traditional weights are typically to get the lure to the right depth in the water and allow for long casts.

Disclosed herein is a collar weight that is configured to be applied directly to, and removed from, the hook on the lure. As shown in FIG. 2, an embodiment of the invention disclosed herein includes a deformable material impregnated with relatively heavy particles and having a shape of a short hollow cylinder or collar. The collar 10 is positioned on or otherwise operably coupled to the hook 5 itself, as shown in FIG. 3, at the location desired by the user to effect not only the depth of the lure in the water, but also the accuracy of the casting of the lure, and how the lure may move when propelled by the fishing line when in the water.

The deformable material may be plastic, natural rubber, or any of many other soft materials that are deformable. The soft material may be suitable for use under water for extended periods of time, as well as provide a good base material for impregnating, mixing, or otherwise combining the particles into the material. Deformable in this context means the soft material forming the collar is deformable to a fixed shape, or it means resiliently deformable to allow deformation temporarily and a rebound to the original shape (fully elastic) or a rebound to a shape between the temporary shape and the original shape (partially elastic).

The heavy particles that are embedded in the soft material may include lead, iron, tungsten, bismuth, stone, or other materials useful for the purpose of at least one intention described herein. The particles may be loaded into the soft material during formation of the material, or may be applied as a coating to the collar 10 after the collar 10 is formed. The particles may be of any size allowing positioning in the collar structure in sufficient number to provide a weighting effect. One such acceptable weighting effect is to have a collar sized and structured to be received on the shank of a hook, such as in FIG. 3, and for each collar to weigh approximately one gram. Other weights greater than and less than one gram are contemplated.

As shown in FIG. 3, one collar 10 or more than one collar 10 may be positioned on the hook 5 at a time to achieve the desired effect. The collar or collars 10 may be positioned at one end of the hook 5, such as the end including the eyelet 30, or the other end of the hook 5, such as the end including the tip 25 and the barb 20, or the collar or collars 10 may be evenly spaced, to create the desired effect on the lure as it is presented to the fish in the water. For example, if more weight is positioned on the hook 5 towards the head end of the lure, the head end of the lure will be biased downwardly. If more weight is positioned on the hook 5 towards the rear end of the lure, the rear end of the lure will be biased downwardly.

In some embodiments, the collars 10 are each a short hollow cylinder, as shown in FIG. 2. The diameter of the central bore 12 of the collar 10 may be sized or otherwise configured to receive at least a portion of the shank 15 of the hook 5. Since the collar 10 is made of a soft material, if the shank 15 of the hook 5 changes dimension along its length, either smaller in dimension or larger in dimension, or is irregular in shape, the collar 10 may seat thereon securely. The collar 10 may be held in position on the hook 5 by a compression fit. This would occur if the central bore 12 of the collar 10 is smaller than the location on the hook 5 where the weight 10 is placed, so the bore 12 of the collar 10 would expand to fit over the shank 15. The fit may be a friction fit, where the bore 12 is substantially the same size as the location on the shank 15 on which the collar 10 is placed, and the soft material is fixed by friction at this location. The fit may be enhanced by a glue, adhesive, or other engagement-enhancing material or liquid which coats the inside wall of the bore 12, or coats the shank 15 where the collar 10 is located. In some embodiments, the collar 10 may be held in place by physical engagement with stops or barriers positioned on or formed into the shank 15 of the hook 5, such as by discrete curves or bumps that are positioned on either end of the location on or in the hook 5 where the collar 10 is to be placed.

The collar 10 is positioned on the shank 15 by putting the bore 12 of the collar 10 over the tip 25 of the hook 5 and pushing the collar 10 to the desired position. The collar 10 may need to be rotated as it is moved along the length of the shaft 15 to effectively screw or otherwise transition the collar 10 up or down to the desired location. The bore 12 of the collar 10 may also be placed over the eyelet 30 on the other end of the hook 5 in order to position the collar 10 on the hook structure 5 as desired.

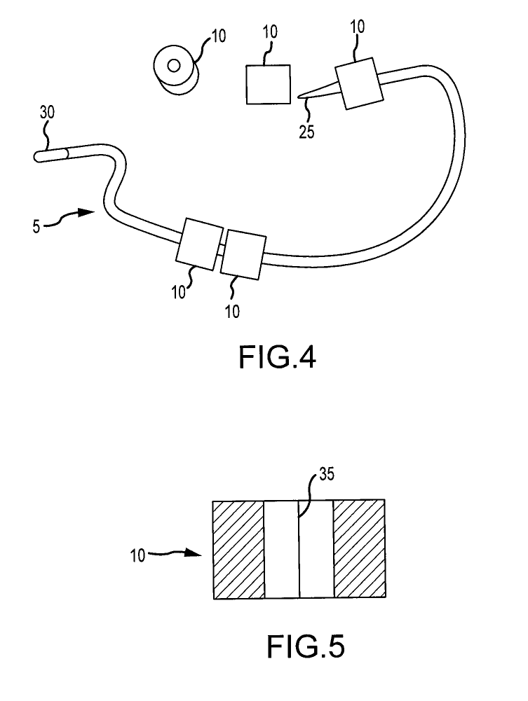

The collar 10 may be removed from the hook 5 by moving the collar 10 back toward the hook tip 25 and pushing the collar 10 over the barb 20 formed thereon. The barb 20 may catch on the sidewalls of the bore 12, but the soft material may allow the collar 10 to pass over the barb 20. If any tearing occurs when pushing the collar 10 over the barb 20 backwards, the soft, resilient nature of the material may allow the collar 10 to continue to work when repositioned on the hook 5. Alternatively, the collar 10 may be removed by moving the collar 10 off the hook 5 over the eyelet end 30 of the hook structure 5. FIG. 4 shows a collar 10 positioned over the barb 20, which is a position common to its being pushed onto the hook 5 or being taken off the hook 5. Two weight collars 10 are also shown adjacent to one another on the shank 15 of the hook 5.

Alternatively, as shown in FIG. 5, the collar 10 may have a slit 35 formed therein to allow the collar 10 to be positioned on the shank 15 by opening or biasing the slit 35 and positioning the shank 15 in the bore 12. The collar 10 may then be positioned along the length of the bore 12 by sliding or screwing or otherwise transitioning the collar 10 to the desired location.

The collar 10 may then be removed by either opening up the slit 35 and removing the shank 15 from the bore 12, or by passing the collar 10 over the barb 20 or eyelet 30 as described above.

The repositionable and removable weight collars 10 may have shapes other than cylindrical. The collar shapes may be geometric (square, triangular, hexagonal, trapezoidal, etc.) or irregular, and may be shorter or longer than those shown. The bore 12 described above may take the form of a slit 35 that is opened just enough to receive the shank 15. It is also contemplated that a collar 10 may not have a bore in it at all, and instead the collar 10 may be pushed over the barb 20 to form its own aperture to pass over the barb and onto the shank 15. It is also contemplated that the collar 10 may not extend all the way around the shank 15, and may instead extend only partially around the shank 15 but still maintain a compressive or frictional engagement. If the collar 10 extends around less than half of the outer circumference of the shank 15, the collar 10 may be held in place permanently or temporarily with a suitable adhesive.

As noted above, application of the collar weights on the hook may help locate the desired weight on the hook to allow for casting a lure with the casting weight concentrated on the lure, as opposed to casting when the weight is positioned both at the lure and positioned above the lure. This may allow for more accurate casting with less risk of tangling the line or lure. Also, the application of the collar weights on the hook may help cause the lure to move through the water (or relative to the water when the lure is still and the water is moving) in a desired presentation (such as angled up or angled down). Where a hook is positioned laterally on the lure, the collar weight may be applied to the lateral hook and cause the lure to move laterally or differently than just in a vertical plane.

The collar weight or weights disclosed herein may also be a component or components of a kit. In other embodiments, the kit may also include a hook, a lure, fishing line, and/or instructions for applying the weight to the hook according to a method disclosed herein or applying the weight to the hook in a specific location such that the lure will move through the water in a desired presentation as described in more detail above. The components of the kit may be packaged together in any appropriate packaging, such as a plastic, molded packaging suitable for display in a retail store.

What is claimed is:

1. A weight for use in fishing comprising
a hook having a body including a shank, an eyelet end and a barb end; and
at least one repositionable weight collar configured to be positioned on said body of said hook.

2. The weight of claim 1, wherein the weight collar is comprised of a deformable material comprising heavy particles.

3. The weight of claim 2, wherein the deformable material is selected from the group consisting of plastic and natural rubber.

4. The weight of claim 2, wherein the heavy particles are selected from the group consisting of lead, iron, bismuth, tungsten and stone.

5. The weight of claim 1, wherein the hook is selected from the group consisting of a single hook, a dual hook, a treble hook and a quad hook.

6. The weight of claim 1 wherein the weight collar further comprises a bore configured to receive at least a portion of the body of the hook.

7. The weight of claim 6, wherein the at least a portion of the body of the hook is the shank.

8. The weight of claim 6, wherein the bore of the weight collar further comprises a slit configured to aid the bore to receive at least a portion of the body of the hook.

9. A weight configured for use in fishing comprising:
a hook having a body; and
a weight collar having a cylindrical shape and a bore formed therein, said weight collar being made of a soft material including a heavy material;
wherein said body of said hook is received in said bore to locate said hook at a desired location on said body of said hook.

10. The weight of claim 9, wherein the soft material is selected from the group consisting of plastic and natural rubber.

11. The weight of claim 9, wherein the heavy material is selected from the group consisting of lead, iron, bismuth, tungsten and stone.

12. The weight of claim 9, wherein the hook is selected from the group consisting of a single hook, a dual hook, a treble hook and a quad hook.

13. A kit comprising
a fishing hook having a body; and
at least one weight collar configured to be positioned on the body of the hook.

14. The kit of claim 13 further comprising a lure.

15. The kit of claim 13 further comprising instructions for positioning the at least one weight collar on the body of the hook.

16. The kit of claim 13, wherein the hook is selected from the group consisting of a single hook, a dual hook, a treble hook and a quad hook.

17. The kit of claim 13, wherein the weight collar is comprised of a deformable material comprising heavy particles.

18. The kit of claim 17, wherein the deformable material is selected from the group consisting of plastic and natural rubber.

19. The kit of claim 17, wherein the heavy particles are selected from the group consisting of lead, iron, bismuth, tungsten and stone.
